(19) United States
(12) Patent Application Publication
(10) Pub. No.: US 2024/0425144 A1
(43) Pub. Date: Dec. 26, 2024

(54) FOLDABLE SWIM PLATFORM

(71) Applicant: Hi Maintenance Sales and Marketing LLC, Salida, CO (US)

(72) Inventor: Kevin Kabler, Salida, CO (US)

(73) Assignee: Hi Maintenance Sales and Marketing LLC, Salida, CO (US)

(21) Appl. No.: 18/750,522

(22) Filed: Jun. 21, 2024

Related U.S. Application Data
(60) Provisional application No. 63/509,967, filed on Jun. 23, 2023.

(51) Int. Cl. B63B 7/08; B63B 7/00; B63B 34/21

(52) U.S. Cl. CPC B63B 7/08; B63B 34/21; B63B 2007/003

(57) ABSTRACT

An inflatable swim platform provides a versatile deployable structure on which a user can enter and exit the water from a vessel. Two or more inflatable dropstitch members are joined by a flexible connector along a longitudinal edge forming a hinge. When deployed the side surfaces along the longitudinal edge of each platform come into contact placing the connector panel in tension and a portion of the side surfaces in compression. An extension mechanisms possessing shape memory integrated into and spanning between the members is biased to the extended position aiding in deployment of the swim platform.

### RELATED APPLICATION

The present application relates to and claims the benefit of priority to U.S. Provisional Patent Application No. 63/509,967 filed 23 Jun. 2023 which is hereby incorporated by reference in its entirety for all purposes as if fully set forth herein.

### BACKGROUND OF THE INVENTION

### Field of the Invention

Embodiments of the present invention relate, in general, to an inflatable swim platform and more particularly to a foldable swim platform attachable to a side of a vessel.

### Relevant Background

Rafting is a popular sport. Indeed, water pleasure/leisure craft is a 40+ billion-dollar industry which is projected to exceed 75 billion in the next 10 years. Whether individuals are experiencing shooting the rapids, merely floating down a picturesque canyon, water skiing, fishing or boating to a nearby beach, experiencing the outdoors via water is a growing pastime. Rafts or inflatable vessels are rapidly becoming the primary means by which individuals transient remote water venues. The inherent low draft (water displacement) and their ability to sustain contact with an occasional obstacle makes them a perfect mode of travel for venturing down small remote canyons and bayous. Similarly, it would be rare to find a body of water in which does not exist one or more small recreational vessels.

Rafts and small vessels vary in size but many carry 6-9 individuals and are relatively easy to transport. The inflatable nature of their structure enables them to be lightweight facilitating transportation of the vessel to a point of entry and, when not in use, easily stored. More traditional vessels are easily transported by trailer and access water venues by numerous launch sites.

Traversing a stream, lake, or a river presents a variety of experiences. In one moment, a rider may be tossed and churned as the raft transports it passengers over some white water, while in other instances the raft and is occupants enjoy a leisurely float down a calm section of flow. In other instances, the passengers of a ski boat are watching friends and family ski, wake board or the like and in other moments joining other boaters on a sand bar or beach to share stories of their experiences.

While versatile, rafts and small leisure craft type present a few challenges. The size of smaller floating structures is such that it can be challenging for an individual in the water to climb back into the craft, should they fall or jump out. And while you can sit on the chambers that form the side of the raft or the sides of a small boat, these chambers and side portions are not designed, nor do they facilitate, occupant interaction with the water. Rafts, unlike other watercraft, do not typically possess deployable ladders on which an individual can climb to regain entry into the raft. And those crafts that do possess ladders are at the rear of the boat presenting a hazardous interaction with the motor and propeller.

Inflatable swim platforms, such as those found on a lake or at a beach enable users to easily interact with the water. These structures usually come in a set size which cannot be varied and which must rely on the integral structural aspects to provide stability. In many instances current swim platforms use a watertight rigid frame constructed of wood or sheet metal that has a central main body portion, with outrigged floatation units. These types of platforms are not collapsible or capable of being stowed in a relatively small area. Other swim platforms include rigid member, that, while providing stability, hinder the ability to stow the swim platform a small enclosure.

Swim platforms are currently not designed to interact directly with small vessels. A need exists for a stowable, swim platform that can be quickly extended from the side of a raft or similar vessel to provide a platform enabling easy entry and exit to both the vessel and the water. A need further exists for a swim platform that can be attached to a vessel as a platform in one instance yet stowed without interfering in the stability or operation of the vessel. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

An inflatable swim platform provides a versatile deployable structure on which a user can easily enter and exit the water from a vessel. Two or more inflatable dropstitch members are joined by a flexible connector along a longitudinal edge proximate to the lower surface thereby forming a hinge. When deployed the side surfaces along the longitudinal edge of each platform come into contact placing the connector panel in tension and the upper portions of the side surfaces in compression. To aid in deployment, extension mechanisms possessing a shape memory are integrated into and span across each member biased to the extended, swim platform configuration. When not in use the inflatable swim platform folds along the connector and is secured alongside the vessel.

In one embodiment of the present invention a foldable swim platform, includes a first dropstitch inflatable planar member and a second dropstitch inflatable planar member wherein each dropstitch inflatable planar member is a cuboid having eight vertices, twelve edges, an upper surface, and a lower surface and a plurality of side surfaces. In other embodiments each planar member may be a variety of geometric shapes, each including at least one longitudinal edge and surface. The platform further includes a flexible connector (connecting panel) spanning between the lower surface of each of the two dropstitch inflatable planar members. Responsive to the lower surface of each of the two dropstitch inflatable planar members forming a substantially congruent planer surface, a first side surface of the first dropstitch inflatable planar member mates with a first side surface of the second dropstitch inflatable planar member. As a downward force is applied on the extended and connected planar members, the connecting panel (connector) is placed in tension with the upper portions of the respective side surfaces placed in compression. To aid in deployment at least one extension mechanism is coupled to, and spans between each inflatable planar. In one version of the present invention the extension mechanism has a shape memory aligned with the congruent planer surface of the swim platform.

In another embodiment of the present invention the connector is a plurality of panels traversing a gap between the lower surface of each of the two dropstitch inflatable planar members and wherein each panel is independently affixed to the lower surface of each of the two dropstitch inflatable planar members.

The extension mechanism in another embodiment of the present invention is composed of a shape memory material selected from the group consisting of NiTi-based, Cu-based (CuAlNi and CuZnAl) and Fe-based alloys. In other versions the extension mechanism is composed of a shape memory polymer, composite and/or hybrid. Indeed, the extension mechanism can also be a spring biased to align with the substantially congruent planer surface. The extension mechanism can be coupled to side surfaces of the inflatable planar member or, in another embodiment, the lower surface(s) of the inflatable planar members.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The features and objects of the present invention, and the manner of attaining them, will become more apparent, and the invention itself will be best understood, by reference to the following description of one or more embodiments taken in conjunction with the accompanying drawings, wherein:

FIGS. 1A and 1B present an upper right perspective view of a foldable swim platform according to one embodiment of the present invention.

FIGS. 2A, 2B and 2C provide top and bottom views of a swim platform comprising two planar members according to one embodiment of the present invention.

FIG. 3 is perspective view of a partially deployed foldable swim platform according to one embodiment of the present invention.

FIG. 4 presents another embodiment of the present invention for coupling planar members together to form a foldable inflatable swim platform.

FIGS. 5A and 5B are end views of partially deployed and fully deployed (respectively) foldable swim platform according to one embodiment of the present invention.

FIG. 6 is yet another embodiment of the present invention showing an alternative configuration of extension mechanism.

The Figures depict embodiments of the present invention for purposes of illustration only. Like numbers refer to like elements throughout. In the figures, the sizes of certain lines, layers, components, elements or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

A stowable, inflatable swim platform attaches to the side of a vessel (raft, watercraft or the like). In its stowed configuration, the platform resides along the side of a raft without impeded the raft's operation or stability. When deployed the swim platform unfolds to provide a planar platform adjacent to and attached to the side of the raft. The platform is ridge when deployed forming a firm deck on which occupants can individually and independently transition from the vessel to the water and from the water to the vessel.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

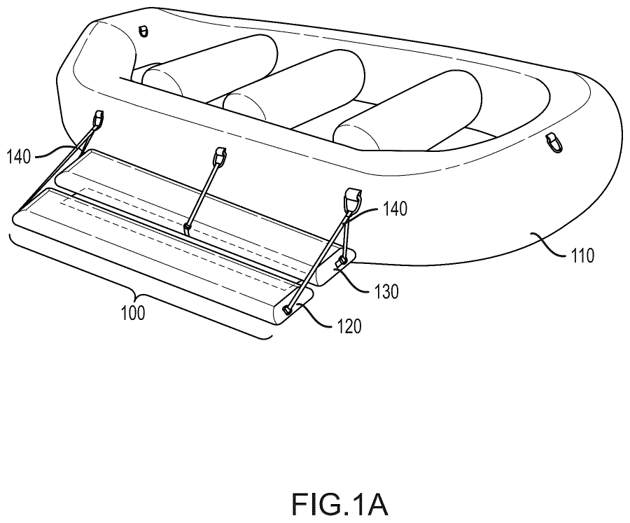

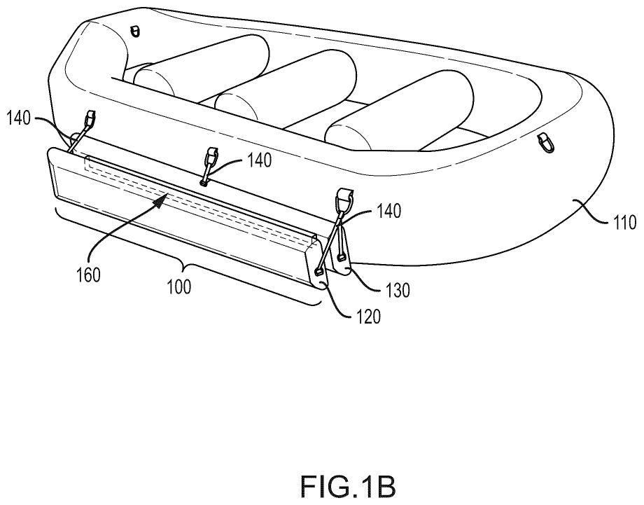

FIGS. 1A and 1B present a forward upper perspective view of a foldable swim platform according to one embodiment of the present invention. The foldable swim platform 100 of the present invention is shown in FIG. 1A in its extended configuration alongside an inflatable raft 110 or similar vessel. The platform shown in this embodiment is bi-fold swim platform having two cuboid planar members 120, 130 joined on substantially the entirety of one of the longitudinal (long) edges. Each of the cuboid planer members 120, 130 comprises an inflatable platform formed from dropstitch construction using material impermeable to water and air. Each member includes an internal structure making the cuboid planer member rigid when full inflated, yet pliable when deflated.

When deployed the two cuboid planar members 120, 130 are positioned side-by-side in the forming a rigid surfaced on which individuals may sit, stand or traverse as the enter and exit the water to and from a vessel. The platform 100 is secured to the raft or vessel by straps 140 supporting the outer and inner edge from downward displacement. For purposes of the discussion, the deployed location is when the swim platform is unfolded and established in the water as a swim platform. A stored configuration is defined as when the two or more cuboid planar members 120, 130 are folded and secured alongside a raft 110 or other supporting vessel for transport. FIG. 1B provides an upper right perspective view of the swim platform 100 in its stored configuration secured to a raft. The platform folds long a longitudinal edge 160 and is secured to the side of the raft/vessel by several attachment points.

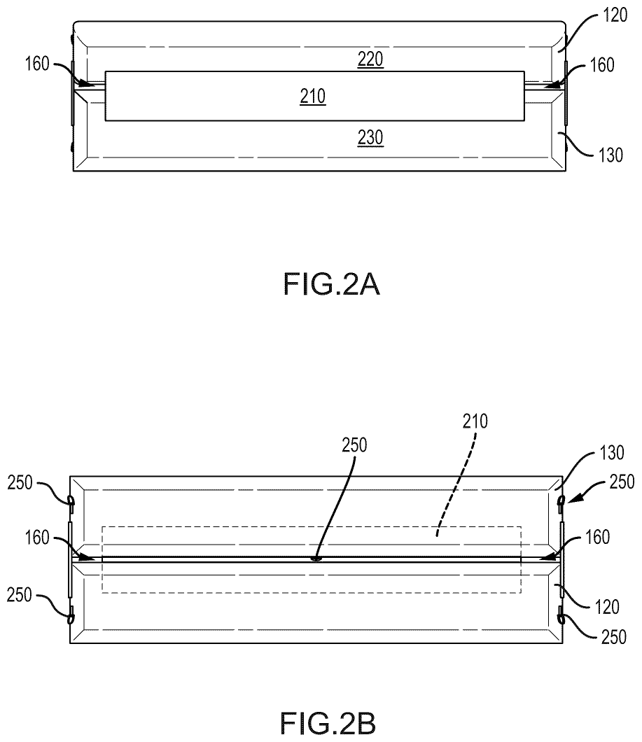

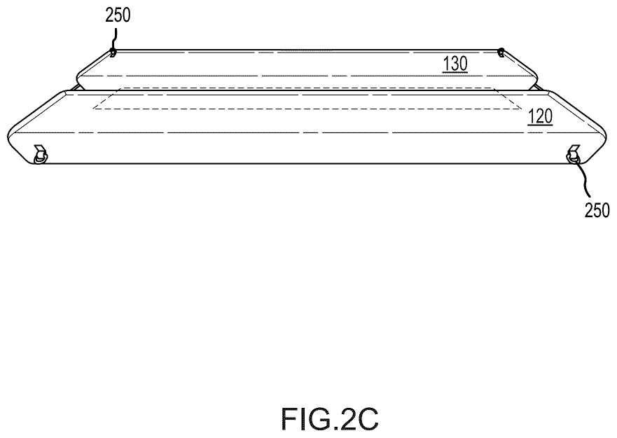

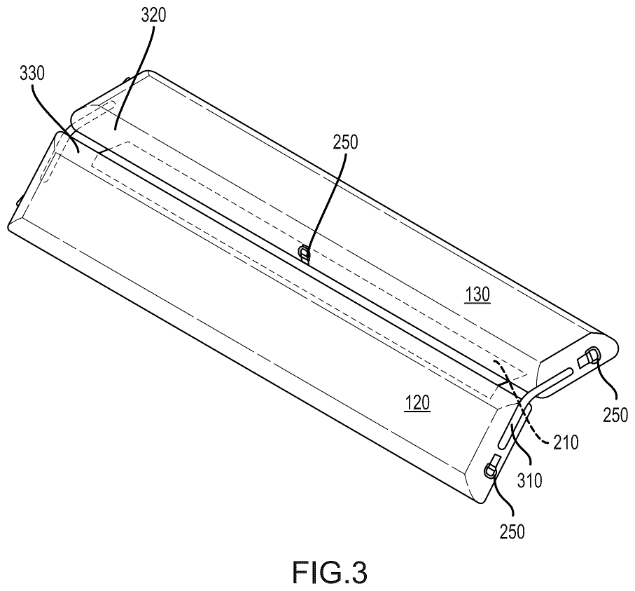

A connecting/joining mechanism 210 flexibly couples a first cuboid planar member 120 to a second cuboid planar member 130 along substantially the entirety of one of each member's longitudinal edges 160. As shown in FIGS. 2A, 2B and 3, a connecting mechanism 210 is configured to be on, and affixed to, a lower edge/surface 220 of each cuboid planar member. As the swim platform is deployed the platform unfolds so that a lower surface 220, 230 of each cuboid planar member is in contact with the water, as is the connecting mechanism 210 coupling together each cuboid planar member 120, 130. FIG. 2A provides a bottom view of the deployed platform 100 with a connector 120 coupling the two cuboid planar members 120, 130 together. In this illustration the connector spans substantially the entire length of the coincident inner longitudinal edge 160 of each cuboid planar member 120, 130. FIG. 2B presents top view of the same platform 100. Note the attachment points 250 by which the platform can be secured to and supported by the associated vessel. FIG. 2C provides an alternative configuration of the attachment points 250 as associated with each inflatable planar member. FIG. 3 presents the platform shown in FIG. 2 in an intermediate deployed configuration. FIG. 3 shows the connector 210 bending (flexing) as the cuboid planar members 120, 130 are brought together to the stowed position. FIG. 3 also illustrates an expansion mechanism 310 in a state of elastic deflection attached to the side of each cuboid members.

As shown in FIGS. 2A, 2B and 3, the longitudinal side surface 320 of a first cuboid planar member 130 is abutted to a longitudinal side surface of a second cuboid planar member. The joining mechanism 210, also referred to herein as a connector, couples the two members 120, 130 together. As force is applied downward on the platform in the deployed configuration, the joining mechanism is placed in tension forcing the upper longitudinal edge and connecting face of each cuboid planar member to compress thereby forming the swim platform. As the connector 210 spans between the lower surface of each cuboid planar member 120, 130, the downward force described above places a portion of each longitudinal side surface 320, 330 of each cuboid planar member 120, 130 in compression.

Each planar member possesses an independent center of gravity and when the two planar members are coupled together by the joining mechanism the platform as an entity possesses a platform center of gravity. As the coupling between the two planar members is not symmetrically rigid a downward force on the outside edge of the deployed inflatable swim platform will displace that edge into the water causing the two planar members to fold at the connector. According to one embodiment of the present invention two or more attachment points 250 are incorporated into each outside edge/surface of each planar member. A flexible strap 140 or the like links the extended or deployed swim platform to the supporting vessel. With the straps 140 in place a downward force on the edge of the planar member 120, 130 outward of the individual planar member center of gravity, places the strap in tension and induces a compressive force on the juncture between the two planar member internal side surfaces and the vessel as well as transferring a portion of the downward force to the vessel, thereby stabilizing the swim platform 100. The straps 140 secure the platform 100 to the side of the vessel and transfer loading forces from the edged of the swim platform 100 to the vessel to prevent inadvertent collapse of the swim platform.

In one embodiment of the present invention each cuboid planar member is 4 inches thick with a lateral width of 12 inches and a longitudinal length of 72 inches. When stowed for transport alongside a raft the swim platform is approximately 72 inches in length, with a height of 12 inches and a width of 8 inches. When deployed the swim platform creates a planar cuboid 72 inches in length, 4 inches thick and approximately 24 inches wide. One of reasonable skill in the relevant art will appreciate that the sizes of each cuboid planar member and indeed the platform itself may vary without departing from the scope of the present invention described herein.

Each cuboid planar member possesses a thickness sufficient to establish independent rigidity and buoyancy in the water. In one version of the present invention each cuboid planar member is formed with a PVC outer shell and a woven dropstitch core. Dropstitch material is made up of thousands of thin strands that secure the top and bottom layers of the inflatable swim platform together. The dropstitch fabric helps the cuboid planar member keep its shape and keeps the air in the cuboid planar member from putting too much pressure on the seams. Moreover, the threads are at an angle rather than spanning directly across the width of the member which makes for a tighter, stronger dropstitch core and an inflatable platform that is nearly as rigid as a solid material. Dropstitch core construction is found in stand-up paddle boards and similar recreational equipment.

The swim platform of the present invention, in the stowed configuration, is configured to be adjacent to the vessel yet configured and attached so as not to interfere with or modify the fluid dynamic characteristics of the vessel. In one embodiment of the present invention the swim platform is configured to be affixed to the side of a raft or inflatable craft. In other embodiments the swim platform is configured to be attached to the side of a hard-shell watercraft or pontoon boat. And in yet another embodiment the swim platform can be used independent of any vessel. While the swim platform of the present invention has been described as formed by two cuboid planar members, in other embodiments different shapes and dimensions may be employed to facilitate different environments and different applications, in each case without departing from the scope and innovative nature of the present invention. For example, two semicircular planar members can similarly be joined at the longitudinal edge for form a rigid circular swim platform.

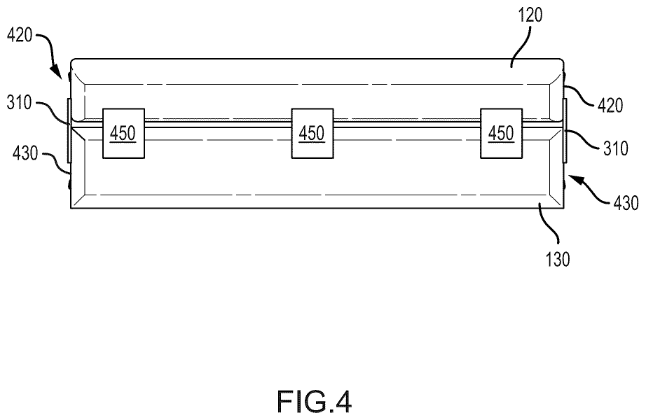

In yet another embodiment and as illustrated in FIG. 4 a semirigid, elastically deformable member 310 or extension mechanism is attached to the end of each cuboid planar member 120, 130. When in the deployed configuration the member aligns with the combined lateral edges 420, 430 of the two cuboid planar members 120, 130. As the swim platform is reconfigured into its stowed configuration the extension member 310 is elastically deformed creating a moment force on the corresponding edges 420, 430 of each cuboid planar member driving them to extend back to the deployed configuration. The semirigid, elastically deformable member 310 provides a deploying force aiding in the extension of each member from the stowed configuration to the deployed configuration. In another embodiment the semirigid, elastically deformable member can be locked into the deployed location providing additional platform stability. FIG. 4 also shows an alternative connector 450 configuration. In this version of the present invention the cuboid planar members 120, 130 are joined by three independent panels 450 spanning across the lower surface. The panels (connectors) 450 bring the longitudinal sides of the cuboid planar members together so that they abut when in the deployed configuration.

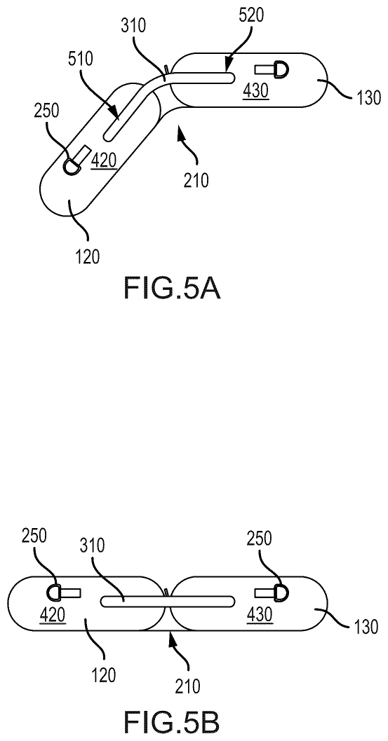

FIGS. 5A and 5B are end views of a swim platform of the present invention in a semi-deployed and deployed state. An extension mechanism 310 is coupled a side surface 420, 430 of each planar member 120, 130. A first end 510 of the extension mechanism 310 is attached to a first side surface 420 of a first planar member and a second end 520 of the extension mechanism 310 is attached to a first side surface 430 of a second planar member 130. The means of attachment may vary. In one embodiment of the present invention pockets can be sewn into each side surface that are configured to accept an extension mechanism 310 when in its deformed/stowed configuration. In other embodiments the extension mechanism 310 can be sewn/attached into the surface of planar member itself. Similarly, the extension mechanism 310 can be affixed to each planar member 120, 130/side surface 420, 430 by one or more attachment points.

In one version of the present invention the elastically deformable member is composed of shape memory material. After being severely and quasi-plastically distorted, shape memory materials (SMMs) can recover their original shape at the presence of the right stimulus.

Shape memory materials (SMMs) are characterized by the ability to recover their original shape from a significant and seemingly plastic deformation when a particular stimulus is applied. This is known as the shape memory effect (SME). Superelasticity (in alloys) or visco-elasticity (in polymers) are also commonly observed under certain conditions. The SME can be utilized in many fields, from aerospace engineering (e.g., in deployable structures and morphing wings) to medical devices (e.g., in stents and filters).

As SMPs have a much higher recoverable strain and normally a wider shape recovery temperature range, it is possible to have more than one intermediate shape in the multi-SME through a proper programming procedure. The one version of the invention the extension mechanism is comprised of shape memory material selected from the group consisting of NiTi-based, Cu-based (CuAlNi and CuZnAl) and Fe-based alloys. In other version of the present invention the extension mechanism is comprised of a shape memory polymer, a shape memory composite or a shape memory hybrid.

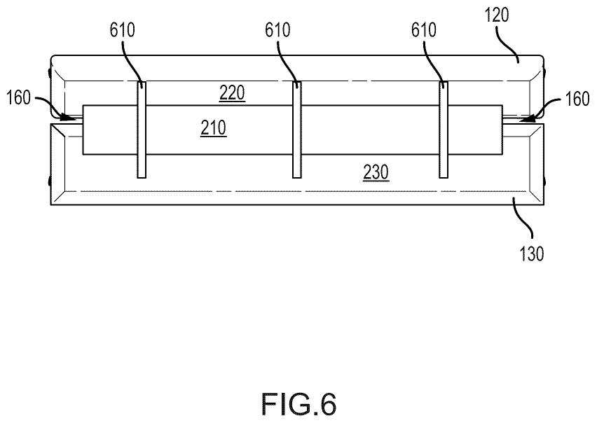

In other embodiments the extension mechanism and/or connector is/are affixed to the lower surface of each planar member in various configurations. FIG. 6 presents additional embodiments for joining the planar members 120, 130 together to form a foldable swim platform. FIG. 6 presents two substantially cuboid planar members 120, 130 having a plurality of extension mechanisms 610 that each independently span the longitudinal edge 160/surface mating the planar members together 120, 130. The extensions mechanisms 610 are attached to the lower surface 220, 230 of the planar members 120, 130 to aid in deployment of the swim platform.

In the embodiment shown in FIG. 6 a single flexible connector 210 or panel joins together the lower surfaces 220, 230 of each planar member 120, 130 spanning the gap between the two members. Traversing the connecting panel are a plurality of extension mechanism 610 attached to the lower surface 220, 230 of each planar member 120, 130. As the members fold along the longitudinal edge about the connecting panel, each extension mechanism elastically deforms creating a force resistant to the stowed configuration.

The inflatable swim platform of the present invention provides a versatile deployable structure on which a user can enter and exit the water from a vessel. Two or more inflatable dropstitch members are joined by a flexible connector along a longitudinal edge forming a hinge. When deployed the side surfaces along the longitudinal edge of each platform come into contact placing the connector panel in tension. To aid in deployment, extension mechanisms possessing shape memory are integrated and biased to the extended, swim platform configuration. When not in use the inflatable swim platform folds along the connector and is secured alongside the vessel.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

While the invention has been particularly shown and described with reference to embodiments, it will be understood by those skilled in the art that various other changes in the form and details may be made without departing from the spirit and scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A foldable swim platform, comprising:
a first dropstitch inflatable planar member and a second dropstitch inflatable planar member wherein each dropstitch inflatable planar member is a cuboid having eight vertices, twelve edges, an upper surface, a lower surface, and a plurality of side surfaces;
a connector spanning between the lower surface of each of the two dropstitch inflatable planar members wherein responsive to the lower surface of each of the two dropstitch inflatable planar members forming a substantially congruent planer surface, a first side surface of the first dropstitch inflatable planar member is in substantial contact with a first side surface of the second dropstitch inflatable planar member; and
at least one extension mechanism coupled to the first dropstitch inflatable planar member and the second dropstitch planar member, wherein the at least one extension mechanism has a shape memory aligned with the substantially congruent planer surface.

2. The foldable swim platform of claim 1, wherein the connector is a flexible panel affixed to a portion of the lower surface of each of the two dropstitch inflatable planar members.

3. The foldable swim platform of claim 1, wherein the connector is a plurality of panels traversing a gap between the lower surface of each of the two dropstitch inflatable planar members and wherein each panel is independently affixed to the lower surface of each of the two dropstitch inflatable planar members.

4. The foldable swim platform of claim 1, wherein the extension mechanism is composed of a shape memory material selected from the group consisting of NiTi-based, Cu-based (CuAlNi and CuZnAl) and Fe-based alloys.

5. The foldable swim platform of claim 1, wherein the extension mechanism is composed of a shape memory polymer.

6. The foldable swim platform of claim 1, wherein the extension mechanism is composed of a shape memory composite.

7. The foldable swim platform of claim 1, wherein the extension mechanism is composed of a shape memory hybrid.

8. The foldable swim platform of claim 1, wherein the extension mechanism is a spring biased to align with the substantially congruent planer surface.

9. The foldable swim platform of claim 1, further comprising a plurality of attachment points configured to secure the first dropstitch inflatable planar member and the second dropstitch inflatable planar member in a stored configuration folded about the connector.

10. The foldable swim platform of claim 1, wherein the extension mechanism is coupled to a second side surface of first dropstitch inflatable planar member and a second side surface of the second dropstitch inflatable planar member.

11. The foldable swim platform of claim 1, wherein the extension mechanism is coupled to the lower surface of the first dropstitch inflatable planar member and a lower surface of the second dropstitch inflatable planar member.

12. A foldable swim platform, comprising:
a first dropstitch inflatable planar member and a second dropstitch inflatable planar member wherein each dropstitch inflatable planar member includes an upper surface, a lower surface, and at least one side surface;
a connector spanning between the lower surface of each of the two dropstitch inflatable planar members wherein responsive to the lower surface of each of the two dropstitch inflatable planar members forming a substantially congruent planer surface, the at least one side surface of the first dropstitch inflatable planar member is in substantial contact with the at least one side surface of the second dropstitch inflatable planar member; and
at least one extension mechanism coupled to the first dropstitch inflatable planar member and the second dropstitch planar member, wherein the at least one extending mechanism has a shape memory aligned with the substantially congruent planer surface.

13. The foldable swim platform of claim 12, wherein the connector is a flexible panel affixed to a portion of the lower surface of each of the two dropstitch inflatable planar members.

14. The foldable swim platform of claim 12, wherein the connector is a plurality of panels traversing a gap between the lower surface of each of the two dropstitch inflatable planar members and wherein each panel is independently affixed to the lower surface of each of the two dropstitch inflatable planar members.

15. The foldable swim platform of claim 12, wherein the extension mechanism is composed of a shape memory material selected from the group consisting of NiTi-based, Cu-based (CuAlNi and CuZnAl), and Fe-based alloys.

16. The foldable swim platform of claim 12, wherein the extension mechanism is composed of a shape memory polymer.

17. The foldable swim platform of claim 12, wherein the extension mechanism is composed of a shape memory composite.

18. The foldable swim platform of claim 12, wherein the extension mechanism is composed of a shape memory hybrid.

19. The foldable swim platform of claim 12, wherein the extending mechanism is a spring biased to align with the substantially congruent planer surface.

20. The foldable swim platform of claim 12, further comprising a plurality of attachment points configured to secure the first dropstitch inflatable planar member and the second dropstitch inflatable planar member in a stored configuration folded about the connector.

21. The foldable swim platform of claim 12, wherein the extension mechanism is coupled to a first side surface of first dropstitch inflatable planar member and an opposing first side surface of the second dropstitch inflatable planar member.
